(19) United States
(12) Patent Application Publication
(10) Pub. No.: US 2025/0381762 A1
(43) Pub. Date: Dec. 18, 2025

(54) VERMICULITE LAMINATED FILM FOR VACUUM INSULATION PANEL, VACUUM INSULATION PANEL HAVING THE SAME AND REFRIGERATOR

(71) Applicant: Samsung Electronics Co., Ltd., Suwon-si (KR)

(72) Inventors: Sunghwan HONG, Suwon-si (KR); Jungsoo LIM, Suwon-si (KR); Yeonkyoung JUNG, Suwon-si (KR)

(21) Appl. No.: 19/262,429

(22) Filed: Jul. 8, 2025

Related U.S. Application Data
(63) Continuation of application No. PCT/KR2025/006946, filed on May 22, 2025.

(30) Foreign Application Priority Data
Jun. 14, 2024 (KR) 10-2024-0077802

(51) Int. Cl. B32B 19/04; B32B 5/30; B32B 37/00; B32B 38/00

(52) U.S. Cl. CPC B32B 19/04; B32B 5/30; B32B 37/0038; B32B 38/0008; B32B 2250/02; B32B 2264/10; B32B 2307/304; B32B 2307/7375; B32B 2309/02; B32B 2309/12; B32B 2310/0409; B32B 2310/14; B32B 2315/00; B32B 2509/10

(57) ABSTRACT

A vermiculite laminated film for a vacuum insulation panel is provided. The vermiculite laminated film includes a first vermiculite sheet including a first surface with a positive charge, a second vermiculite sheet including a second surface with a positive charge and laminated on the first vermiculite sheet to allow the second surface to face the first surface of the first vermiculite sheet, and an anion interlayer between the first surface and the second surface.

### CROSS-REFERENCE TO RELATED APPLICATION(S)

This application is a continuation application, claiming priority under 35 U.S.C. § 365 (c), of an International application No. PCT/KR2025/006946, filed on May 22, 2025, which is based on and claims the benefit of a Korean patent application number 10-2024-0077802, filed on Jun. 14, 2024, in the Korean Intellectual Property Office, the disclosure of which is incorporated by reference herein in its entirety.

### TECHNICAL FIELD

The disclosure relates to a vermiculite laminated film for a vacuum insulation panel, a vacuum insulation panel including the same, and a refrigerator.

### BACKGROUND ART

Vermiculite is a layered mineral in which vermiculite sheets, each including 2 tetrahedral silicate sheets and 1 Mg-based octahedral sheet, are laminated. While strong chemical bonds such as covalent or ionic bonds are formed in the vermiculite sheet, and the vermiculite sheets bind to each other by weak attractive force such as Van der Waals force.

A vermiculite laminated film in which the vermiculite sheets are assembled includes the vermiculite sheets and an interlayer including cations and interposed between the vermiculite sheets, and the interlayer may provide an inter-layer distance of several Å by the weak Van der Waals bond between the vermiculite sheets.

In addition, because moisture contained in the interlayer includes a liquid transformed into a liquid phase, the moisture of the interlayer partially expands while evaporating by heat applied thereto, so as to form an asymmetric structure.

Meanwhile, because the tetrahedral silicate sheet, the outermost region of the vermiculite sheet, includes oxygen atoms, the surface of the vermiculite sheet has a negative charge, and therefore, the interlayer between the vermiculite sheets may include cations or may be substituted with cations.

In order to decrease vertical thermal conductivity of conventional vermiculite, a method of replacing the cations in the interlayer with larger cations has been studied. However, there are limits to obtain a sufficient inter-layer distance between vermiculite sheets due to the ion size of the cations, and accordingly there are limits to lower vertical thermal conductivity.

The above information is presented as background information only to assist with an understanding of the disclosure. No determination has been made, and no assertion is made, as to whether any of the above might be applicable as prior art with regard to the disclosure.

### DISCLOSURE

### Technical Problem

Aspect of the disclosure are to address at least the above-mentioned problems and/or disadvantages and to provide at least the advantages described below. Accordingly, an aspect of the disclosure is to provide a vermiculite laminated film for a vacuum insulation panel, a vacuum insulation panel including the same, and a refrigerator, wherein the vermiculite laminated film may lower vertical thermal conductivity and improve insulation performance by sufficiently obtaining an inter-layer distance between vermiculite sheets by modifying the surfaces of the vermiculite sheets to have a positive charge and disposing an anion interlayer between the surface-modified vermiculite sheets.

Another aspect of the disclosure is to provide a vermiculite laminated film for a vacuum insulation panel, a vacuum insulation panel including the same, and a refrigerator, wherein the vermiculite laminated film may reduce or replace the use of a conventional getter by improving the ability to adsorb CO₂ gas and N₂ gas and the ability to adsorb H₂O.

Additional aspects will be set forth in part in the description which follows and, in part, will be apparent from the description, or may be learned by practice of the presented embodiments.

### Technical Solution

In accordance with an aspect of the disclosure, a vermiculite laminated film for a vacuum insulation panel is provided. The vermiculite laminated film includes a first vermiculite sheet including a first surface with a positive charge, a second vermiculite sheet including a second surface with a positive charge and laminated on the first vermiculite sheet to allow the second surface to face the first surface of the first vermiculite sheet, and an anion interlayer between the first surface and the second surface.

In accordance with another aspect of the disclosure, a method of manufacturing a vermiculite laminated film for a vacuum insulation panel is provided. The method includes modifying a first surface of a first vermiculite sheet and a second surface of a second vermiculite sheet to have a positive charge, and inducing substitution with anions in an interlayer between the first surface and the second surface, both modified to have a positive charge.

In accordance with another aspect of the disclosure, a vacuum insulation panel is provided. The vacuum insulation panel includes an outer shell material sealing an inside of the vacuum insulation panel in a vacuum state, and a core material provided inside the outer shell material, wherein the core material includes a vermiculite laminated film including a first vermiculite sheet including a first surface with a positive charge, a second vermiculite sheet including a second surface with a positive charge and laminated on the first vermiculite sheet to allow the second surface to face the first surface of the first vermiculite sheet, and an anion interlayer between the first surface and the second surface.

In accordance with another aspect of the disclosure, a refrigerator is provided. The refrigerator includes an outer cabinet defining the exterior appearance, an inner cabinet provided inside the outer cabinet and constituting a storage compartment, and a vacuum insulating panel disposed between the outer cabinet and the inner cabinet, wherein the vacuum insulation panel includes a vermiculite laminated film including a first vermiculite sheet including a first surface with a positive charge, a second vermiculite sheet including a second surface with a positive charge and laminated on the first vermiculite sheet to allow the second surface to face the first surface of the first vermiculite sheet, and an anion interlayer between the first surface and the second surface.

### Advantageous Effects

According to the disclosure, a vermiculite laminated film for a vacuum insulation panel and a vacuum insulation panel including the same may be provided. By modifying the surfaces of the vermiculite sheets to have a positive charge and disposing the anion interlayer between the surface-modified vermiculite sheets, a sufficient inter-layer distance between the vermiculite sheets may be obtained, so that not only vertical thermal conductivity may be reduced, but also insulation performance may be improved, and furthermore the ability to adsorb CO₂ gas and N₂ gas and the ability to adsorb H₂O may be improved, thereby reducing or replacing the use of a conventional getter.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 is a diagram illustrating a vermiculite laminated film according to an embodiment of the disclosure;

FIG. 2 is a diagram illustrating a structure of a conventional vermiculite laminated film according to an embodiment of the disclosure;

FIG. 3 is a diagram illustrating vertical thermal conductivity in a vermiculite laminated film having the structure of FIG. 1 according to an embodiment of the disclosure;

FIG. 4 is a diagram illustrating vertical thermal conductivity in a conventional vermiculite laminated film having the structure of FIG. 2 according to an embodiment of the disclosure;

FIG. 5 is a flowchart of a method of manufacturing a vermiculite laminated film according to an embodiment of the disclosure;

FIG. 6 is a diagram illustrating a vacuum insulation panel according to an embodiment of the disclosure;

FIG. 7 is a diagram illustrating a vermiculite laminated film according to an embodiment of the disclosure.

FIG. 8 is a diagram illustrating the exterior of a refrigerator according to an embodiment of the disclosure;

FIG. 9 is a cross-sectional view of a refrigeration according to an embodiment of the disclosure;

FIG. 10 is a partially enlarged view of FIG. 9 according to an embodiment of the disclosure; and

FIG. 11 is a graph illustrating Z-potential values of a vermiculite laminated film including an anion interlayer and a vermiculite laminated film including a conventional cation interlayer with respect to pH levels according to an embodiment of the disclosure.

The same reference numerals are used to represent the same elements throughout the drawings.

### MODES OF THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms used herein are merely used to describe particular embodiments. In addition, it is to be understood that the terms such as “including” or “having” are intended to indicate the existence of features, steps, functions, components, or combinations thereof disclosed in the specification, and are not intended to preclude the possibility that other features, steps, functions, components, or combinations thereof may exist or may be added.

Meanwhile, unless otherwise defined, all terms used herein have the same meaning as commonly understood by one of ordinary skill in the art to which this disclosure belongs. Thus, these terms should not be interpreted in an idealized or overly formal sense unless expressly so defined herein. As used herein, the singular forms are intended to include the plural forms as well, unless the context clearly indicates otherwise.

Also, the terms “about”, “substantially”, etc. used throughout the specification means that when an inherent manufacturing and material tolerance is suggested, the tolerance corresponds to a value or is close to the value, and such values are intended for the sake of clear understanding of the disclosure or to prevent an unconscious infringer from illegally using the disclosure.

In general, vermiculite has a structure in which a plurality of vermiculite sheets are laminated, wherein the vermiculite sheet includes two tetrahedral sheet formed of silicate and an octahedral sheet formed of Mg/Al interposed therebetween, and a cation-containing interlayer is interposed between the vermiculite sheets.

Because the tetrahedral sheet constituting the outermost area of the vermiculite sheet includes oxygen atoms, the surface of the vermiculite sheet is negatively charged, so that the interlayer between the vermiculite sheets consists of cations.

In addition, an inter-layer distance between the vermiculite sheets is limited because a maximum ion size of the cation is about 3 Å.

Accordingly, in the disclosure, a sufficient average inter-layer distance between the vermiculite sheets is obtained by substituting the cations contained in the interlayer between the vermiculite sheets with anions by modifying the surfaces of the vermiculite sheets with a positive charge, so that vertical thermal conductivity of a vermiculite laminated film may be reduced, and furthermore insulation performance of a vacuum insulation panel including the vermiculite laminated film may further be improved.

In the disclosure, the vermiculite laminated film refers to common vermiculite having a structure in which a plurality of vermiculite sheets, each including two tetrahedral sheets and an octahedral sheet interposed therebetween, are laminated, and the interlayer refers to a layer disposed between the vermiculite sheets in the structure where the plurality of vermiculite sheets are laminated.

In addition, in the disclosure, the vermiculite laminated film may be vermiculite having a structure in which the vermiculite sheets are laminated, or vermiculite reassembled after being exfoliated from vermiculite having the vermiculite sheet laminated structure into vermiculite sheets.

In addition, in the vermiculite laminated film, the vermiculite laminated film may also be referred to as “vermiculite”, “laminated vermiculite”, “vermiculite laminate structure”, or the like, and the vermiculite sheet may also be referred to as “vermiculite material layer” or “vermiculite layer”. However, the embodiment is not limited to these terms, the terms may be replaced with any term as long as the term indicates the structure including vermiculite sheets, each including two tetrahedral sheets and an octahedral sheet interposed therebetween, and an interlayer interposed therebetween.

In addition, the terms “surface of the vermiculite sheet”, “first surface”, and “second surface” as used herein refer to outermost areas of the vermiculite sheet (oxygen atoms constituting the tetrahedral sheets), i.e., outermost surface of the vermiculite sheet in the plane direction. The term “surface” may be replaced with “plane”, “side”, or the like, but the embodiment is not limited thereto.

Hereinafter, a vermiculite laminated film for a vacuum insulation panel according to an embodiment of the disclosure will be described in detail.

A vermiculite laminated film for vacuum insulation panels according to an embodiment of the disclosure includes: a first vermiculite sheet including a first surface with a positive charge; a second vermiculite sheet including a second surface with a positive charge and laminated on the first vermiculite sheet to allow the second surface to face the first surface of the first vermiculite sheet; and an anion interlayer between the first surface and the second surface.

The first surface of the first vermiculite sheet and the second surface of the second vermiculite sheet may be surface-modified with a positive charge.

In the disclosure, the surfaces of the vermiculite sheets may be modified with a positive charge to substitute the cations constituting the conventional interlayer with anions having a relatively great ion size.

Specifically, via nitrogen-containing plasma treatment performed on the first surface of the first vermiculite sheet and the second surface of the second vermiculite sheet or via direct reaction between the first and second surfaces and the amine compound, the first surface of the first vermiculite sheet and the second surface of the second vermiculite sheet may be modified to include an amine group, thereby having a positive charge.

In addition, because the first surface of the first vermiculite sheet and the second surface of the second vermiculite sheet have a positive charge, the interlayer between the first surface and the second surface may include anions.

In this regard, the anions may include halogen elements, specifically, at least one selected from CI, Br, I, and F.

Because the anions are larger than the cations included in the interlayer of the conventional vermiculite laminated film, by including the anions, the inter-layer distance between the vermiculite sheets may increase due to the ion size of the anions, and accordingly, vertical thermal conductivity of the vermiculite laminated film may be reduced, and furthermore, improved vertical insulation performance may be provided to a vacuum insulation panel to which the vermiculite laminated film is applied.

The inter-layer distance between the vermiculite sheets may vary according to the size of the anions, specifically, the average inter-layer distance between the vermiculite sheets may be at least 3.3 Å but not more than 4.5 Å. In the case where the average inter-layer distance between the vermiculite sheets is within the range described above, vertical thermal conductivity may be efficiently reduced, and vertical insulation performance may also be effectively improved.

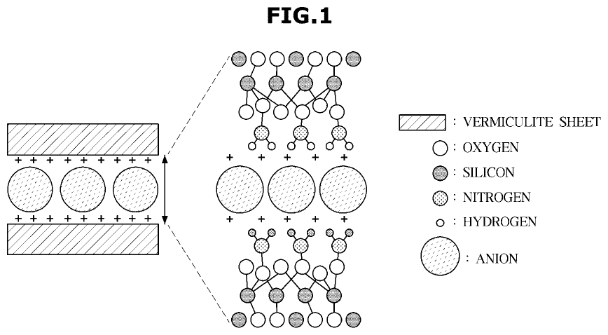

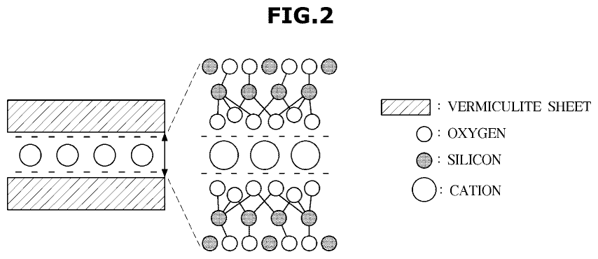

FIG. 1 is a diagram illustrating a structure of a vermiculite laminated film including a first surface of a first vermiculite sheet and a second surface of a second vermiculite sheet, both having a positive charge, and an anion interlayer between the first surface and the second surface according to an embodiment of the disclosure. FIG. 2 is a diagram illustrating a structure of a conventional vermiculite laminated film according to an embodiment of the disclosure.

Referring to FIG. 1, the vermiculite laminated film according to an embodiment of the disclosure includes a first vermiculite sheet including a first surface with a positive charge, a second vermiculite sheet including a second surface with a positive charge and laminated on the first vermiculite sheet to allow the second surface to face the first surface of the first vermiculite sheet, and an anion interlayer between the first surface and the second surface. In the disclosure, by including the anions having a greater ion size instead of the cations contained in the interlayer of the conventional vermiculite laminated film illustrated in FIG. 2, a vermiculite laminated film having an increased inter-layer distance between the vermiculite sheets may be obtained according to the ion size of the anions.

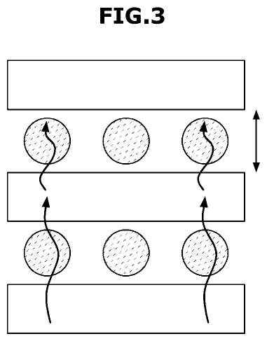

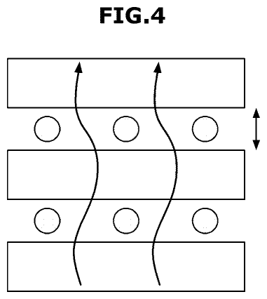

FIG. 3 is a diagram illustrating vertical thermal conductivity in a vermiculite laminated film having the structure of FIG. 1 according to an embodiment of the disclosure. FIG. 4 is a diagram illustrating vertical thermal conductivity in a conventional vermiculite laminated film having the structure of FIG. 2 according to an embodiment of the disclosure.

Referring to FIG. 3, because the vermiculite laminated film according to the disclosure includes anions having a greater ion size than that of the conventional vermiculite laminated film (FIG. 4) including cations in the interlayer, the average inter-layer distance between the vermiculite sheets may increase, so that vertical thermal conductivity may be reduced.

The vertical thermal conductivity of the vermiculite laminated film for vacuum insulation panels according to the disclosure in a vacuum may be 8 mW/mK or less, preferably 7.6 mW/mK or less, and more preferably from 6.0 to 7.6 mW/mK. In the case where the vertical thermal conductivity in a vacuum satisfies the range described above, the vertical thermal conductivity may be efficiently reduced resulting in effective improvement of insulation performance when applied to the vacuum insulation panel.

In addition, in the vermiculite laminated film for vacuum insulation panels according to the disclosure, the first surface of the first vermiculite sheet and the second surface of the second vermiculite sheet are modified with an amine group, resulting in improvement of at least one of the ability to adsorb and the ability to adsorb moisture. Specifically, the vermiculite laminated film may have a CO₂ gas adsorption capacity of 2.5 mmol/g or more, a N₂ gas adsorption capacity of 4 mmol/g or more under conditions of 1 atm. In addition, the vermiculite laminated film may have a moisture adsorption capacity of 194 mmol/g or more.

Hereinafter, a method of manufacturing the vermiculite laminated film for vacuum insulation panels according to an embodiment of the disclosure will be described.

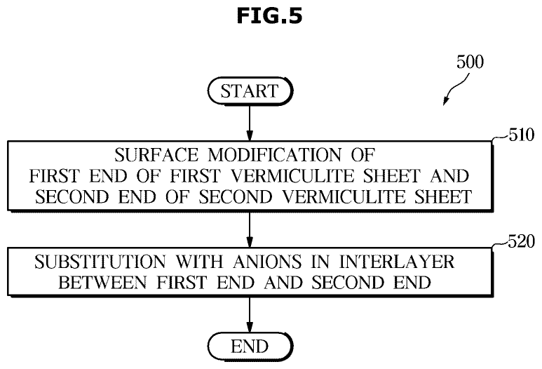

Referring to FIG. 5, a method 500 of manufacturing the vermiculite laminated film for vacuum insulation panels according to an embodiment of the disclosure includes, at operation 510, modifying a first surface of a first vermiculite sheet and a second surface of a second vermiculite sheet to have a positive charge. The method 500 further includes, at operation 520, substituting the interlayer with anions disposed between the first surface and the second surface modified with the positive charge.

The surface modification 510 may be performed by N-containing plasma treatment conducted on the first surface of the first vermiculite sheet and the second surface of the second vermiculite sheet. Specifically, the N-containing plasma treatment may be performed by plasma treatment using NH₃ or N₂ gas.

More specifically, in the case of using NH₃ gas during the N-containing plasma treatment, 10 to 100 MHz of plasma may be applied at a power of 100 to 400 W at a temperature of 15 to 200° C. under a pressure of 100 to 300 mTorr for 5 seconds to 10 minutes.

In addition, in the case of using N₂ gas, 10 to 100 MHz of plasma may be applied at a power of 100 to 500 W at a temperature of 15 to 200° C. under a pressure of 50 to 500 mTorr for 5 seconds to 10 minutes.

In the case where the first surface of the first vermiculite sheet and the second surface of the second vermiculite sheet are subjected to the N-containing plasma treatment, the first surface and the second surface may be modified with amine groups (—NH₂) via the reactions schemes 1 or 2 below.

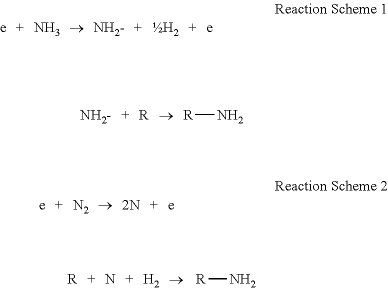

(In Reaction Scheme 1 and Reaction Scheme 2, R is silicate constituting the first surface of the first vermiculite sheet or the second surface of the second vermiculite sheet.)

Also, in addition to the surface modification by the N-containing plasma treatment, surface treatment may also be performed by adding an amine compound to the first surface of the first vermiculite sheet and the second surface of the second vermiculite sheet to bind the amine group thereto.

In this case, the amine compound may include at least one amine compound selected from primary amine, secondary amine, and tertiary amine, and the surface of the vermiculite sheet may be functionalized with an amine group by adding such an amine compound. The amine compound may include at least one selected from monoethanolamine, diethanolamine, triethanolamine, methyldiethanolamine, ethyldiethanolamine, dodecyldiethanolamine, phenyldiethanolamine, diphenylethanolamine, p-hydroxyphenyldiethanolamine, p-hydroxycyclohexylethylethanolamine, diethylethanolamine, and dimethylethanolamine.

In the case of performing AETES treatment, C, SiO, and the like, instead of the amine group, bind to the first surface of the first vermiculite sheet and the second surface of the second vermiculite sheet, failing to obtain the effects of reducing vertical thermal conductivity of the vermiculite laminated film and improving insulation performance of the vacuum insulation panel including the vermiculite laminated film. However, in the case of surface modification by the N-containing plasma treatment according to the disclosure as described above, the amine group directly binds to the first surface of the first vermiculite sheet and the second surface of the second vermiculite sheet, so that the number of atoms vertically binding thereto decreases, thereby obtaining the effects of reducing vertical thermal conductivity of the vermiculite laminated film and improving insulation performance of the vacuum insulation panel including the vermiculite laminated film.

In the case where the first surface of the first vermiculite sheet and the second surface of the second vermiculite sheet are modified to have a positive charge by including the amine group via the surface modification, substitution with anions may be induced in the interlayer between the first surface and the second surface.

In the case of the conventional vermiculite laminated film, substitution with anions in the interlayer was impossible because a Zeta potential value was a negative charge throughout the entire pH range. However, according to the disclosure, by modifying the first surface of the first vermiculite sheet and the second surface of the second vermiculite sheet of the vermiculite laminated film to have a positive charge as described above, substitution with anions may be possible in the interlayer because the surfaces have a positive charge at a pH of 7 or less.

The substitution with anions 520 may be performed by applying a halide to the interlayer between the first surface and the second surface modified with the positive charge, and performing reaction. In this regard, heat treatment may be performed to increase reaction speed, to reduce time, and the like.

Specifically, substitution with anions may be induced by the reaction represented by Reaction Scheme (3) below by applying an aqueous solution of a halide compound to the interlayer between the first surface and the second surface, and performing reaction.

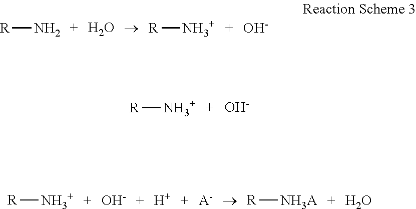

(In Reaction Scheme 3, R is silicate constituting the first surface of the first vermiculite sheet and the second surface of the second vermiculite sheet, and A is at least one halogen element selected from Cl⁻, Br⁻, I⁻, and F⁻.)

In this regard, the halide compound may be a compound including at least one halogen element selected from Cl⁻, Br⁻, I⁻, and F⁻, and a counter cation of the halogen element may include Na⁺, K⁺, Ca²⁺, Mg²⁺, Li⁺, and the like.

The substitution with anions 520 may be easily induced at a higher concentration of the aqueous solution of the halide compound, and for example, the concentration of the halide compound may be 0.1 to 36 wt %.

In addition, the amine group is not appropriately ionized at a too high pH of the aqueous solution of the halide compound, making the substitution with anions difficult. Thus, the pH may be adjusted to 7 or less.

In addition, the substitution with anions 520 may be performed at room temperature.

In the vermiculite laminated film including the substituted anions in the interlayer as described above, the average inter-layer distance between the first surface and the second surface is at least 3.3 Å but not more than 4.5 Å. By increasing the inter-layer distance, vertical thermal conductivity may be effectively reduced, and insulation performance of the vacuum insulation panel including the vermiculite laminated film with reduced vertical thermal conductivity may be efficiently improved.

Hereinafter, a vacuum insulation panel according to an embodiment of the disclosure will be described.

A vacuum insulation panel according to an embodiment of the disclosure includes an outer shell material that seals the inside in a vacuum state and a core material provided inside the outer shell material, wherein the core material includes: a first vermiculite sheet including a first surface with a positive charge; a second vermiculite sheet including a second surface with a positive charge and laminated on the first vermiculite sheet to allow the second surface to face the first surface of the first vermiculite sheet; and an anion interlayer between the first surface and the second surface.

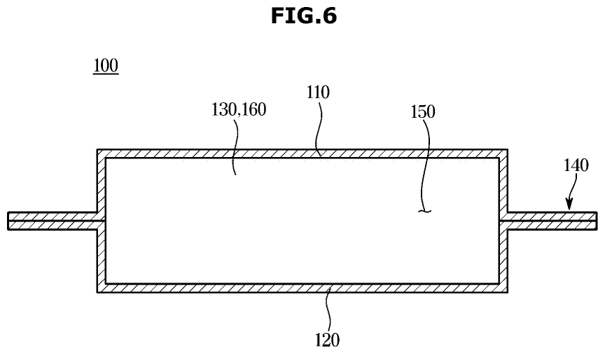

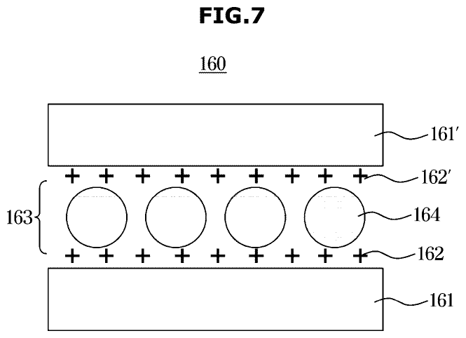

FIG. 6 is a diagram illustrating a vacuum insulation panel according to an embodiment of the disclosure. FIG. 7 is a diagram illustrating a vermiculite laminated film included in a vacuum insulation panel according to an embodiment of the disclosure.

Referring to FIG. 6, a vacuum insulation panel 100 according to an embodiment of the disclosure includes outer shell materials 110 and 120 that seal the inside in a vacuum state, and a core material 130 provided in the outer shell materials 110 and 120, wherein the core material 130 includes a vermiculite laminated film including: a first vermiculite sheet including a first surface with a positive charge; a second vermiculite sheet including a second surface with a positive charge and laminated on the first vermiculite sheet to allow the second surface to face the first surface of the first vermiculite sheet; and an anion interlayer between the first surface and the second surface.

The vacuum insulation panel 100 may include the outer shell materials 110 and 120 that seal the inside in a vacuum state, and the core material 130 provided inside the outer shell materials 110 and 120 and withstanding atmospheric pressure. The core material 130 may be glass fiber or fumed silica that have high durability and low thermal conductivity. The outer shell materials 110 and 120 may be a material, deposited with a metal with low gas and moisture permeability and an inorganic material, or aluminum foil.

The core material 130 may include the above-described vermiculite laminated film according to the disclosure.

Referring to FIG. 7, a vermiculite laminated film 160 includes a first vermiculite sheet 161 including a first surface 162 with a positive charge; a second vermiculite sheet 161′ including a second surface 162′ with a positive charge and laminated on the first vermiculite sheet 161 to allow the second surface 162′ to face the first surface 162 of the first vermiculite sheet 161; and an interlayer 163 between the first surface 162 and the second surface 162′, wherein the interlayer 163 includes anions 164.

The core material 130 may include 0.1 to 10 vol %, preferably 0.1 to 3.4 vol % of the vermiculite laminated film 160. In the case where the content of the vermiculite laminated film 160 is within the range described above, vertical thermal conductivity of the vermiculite laminated film 160 may be efficiently reduced, thereby obtaining optimal insulation performance.

In the vacuum insulation panel 100 including the vermiculite laminated film 160 according to the disclosure, the inside of the outer shell materials 110 and 120 have improved ability to adsorb CO₂ gas and N₂ gas and improved ability to adsorb moisture due to the amine group included in the first surface 162 of the first vermiculite sheet 161 and the second surface 162′ of the second vermiculite sheet 161′ of the vermiculite laminated film 160, so that a conventional getter (not shown) may not be used or the amount of use thereof may be minimized.

Hereinafter, a refrigerator according to an embodiment of the disclosure will be described.

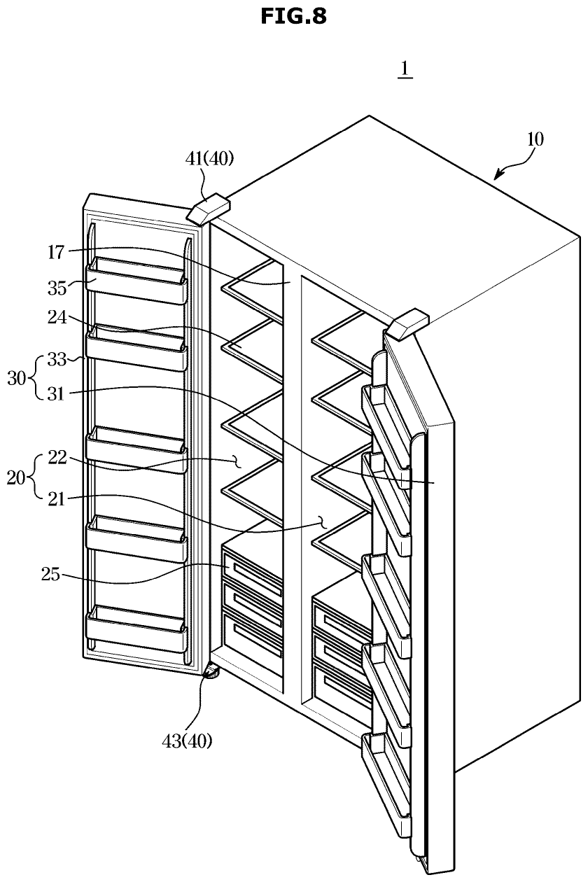

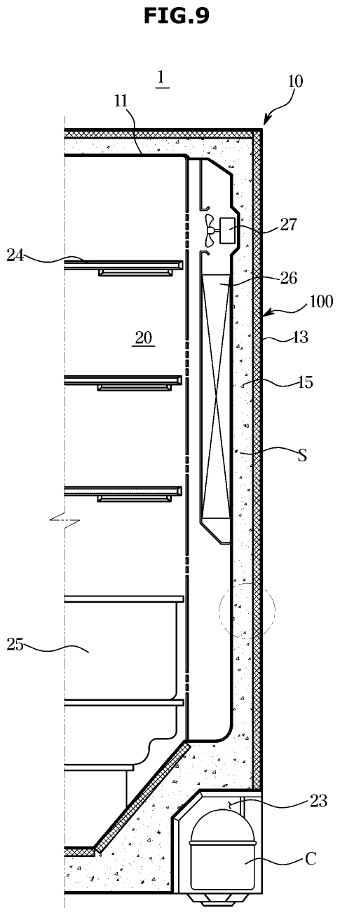

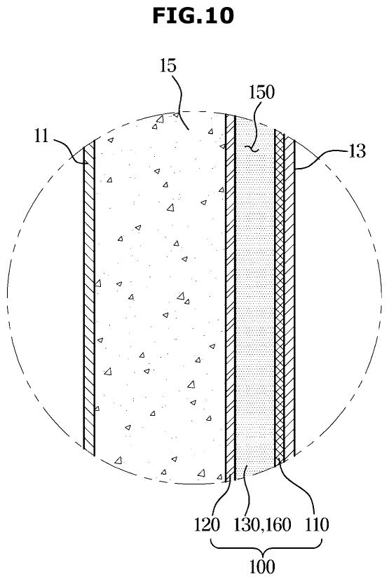

FIG. 8 is a diagram illustrating the exterior of a refrigerator according to an embodiment of the disclosure. FIG. 9 is a cross-sectional view of a refrigeration according to an embodiment of the disclosure. FIG. 10 is a partially enlarged view of FIG. 9 according to an embodiment of the disclosure.

Referring to FIGS. 8 to 10, a refrigerator 1 may include a main body 10 defining the exterior appearance, and a storage compartment 20 provided inside the main body 10 and having an open front.

The main body 10 includes an inner cabinet 11 defining the storage compartment 20, an outer cabinet 13 defining the exterior appearance, and a cool air supply device configured to supply cool air to the storage compartment 20.

The cool air supply device may include a compressor C, a condenser (not shown), an expansion valve (not shown), an evaporator 26, a blower fan 27, etc., and a foam insulation material 15 may be applied between the inner cabinet 11 and the outer cabinet 13 of the main body 10 to prevent cool air from leaking from the storage compartment 20.

A machine room 23, in which the compressor C and the condenser configured to compress a refrigerant and condense the compressed refrigerant are installed, may be provided at a lower rear region of the main body 10.

The storage compartment 20 may be divided into right and left storage compartments by a partition 17. A refrigerating chamber 21 may be provided on the right side of the main body 10, and a freezing chamber 22 may be provided on the left side of the main body 10.

The refrigerator 1 may further include a door 30 to open and close the storage compartment 20.

The refrigerating chamber 21 and the freezing chamber 22 are open and closed by a refrigerating chamber door 31 and a freezing chamber door 33, both pivotally coupled to the main body 10, respectively, and a plurality of door guards 35 may be provided on the rear surface of the refrigerating chamber door 31 and the freezing chamber door 33 to accommodate food.

A plurality of shelves 24 may be provided in the storage compartment 20 to divide the storage compartment 20 into a plurality of spaces, and items such as food are loaded on shelves 24.

In addition, a plurality of storage boxes 25 may be provided to slide into and out of the storage compartment 20.

The refrigerator 1 may further include a hinge module 40 including an upper hinge 41 and a lower hinge 43 allowing the door 30 to be pivotally coupled to the main body 10.

Referring to FIG. 9, a foaming space S may be provided between the inner cabinet 11 constituting the storage compartment 20 and the outer cabinet 13 coupled to the outer side of the inner cabinet 11 and defining the exterior appearance, and the foam insulation material 15 is filled in the foaming space S.

To reinforce the insulation properties of the foam insulation material 15, the vacuum insulation panel (VIP) 100 may be used together with the foam insulation material 15.

Referring to FIG. 10, the vacuum insulation panel 100 may consist of outer shell materials 110 and 120 and a core material 130.

The outer shell materials 110 and 120 block minute gas and moisture penetrating into the vacuum state, thereby maintaining lifespan of the vacuum insulation panel 100. The outer shell materials 110 and 120 of the vacuum insulation panel 100 may include a first outer shell material 110 and a second outer shell material 120.

The first outer shell material 110 may be disposed outside the core material 130. The second outer shell material 120 may be coupled to the first outer shell material 110 to form an accommodation space 150 in which the core material 130 is accommodated. In addition, the second outer shell material 120 may be coupled to the first outer shell material 110 to form an accommodation space 150 to accommodate the core material 130.

The first outer shell material 110 and the second outer shell material 120 may be bonded to each other by fusion or adhesion. In the case where the first outer shell material 110 and the second outer shell material 120 are bonded to each other by fusion or adhesion, a gap or passage through which at least one of gas and moisture passes is closed, and thus penetration of at least one of gas and moisture through the core material 130 may become difficult. Therefore, insulation properties and durability of the vacuum insulation panel 100 may be improved.

The first outer shell material 110 and the second outer shell material 120 may be formed of materials having the same or different heat transfer rates.

In the case where the first outer shell material 110 and the second outer shell material 120 have different heat transfer rates, the first outer shell material 110 having a lower heat transfer rate may be disposed outside the core material 130 to face the inner surface of the outer cabinet 13. The second outer shell material 120 having a higher heat transfer rate may be disposed outside the core material 130 to face the outer surface of the inner cabinet 11 and may be coupled to the first outer shell material 110 to form an accommodation space 150 in which the core material 130 is accommodated.

The first outer shell material 110 may be bonded to the inner surface of the outer cabinet 13. By bonding the first outer shell material 110 with a lower heat transfer rate to the inner surface of the outer cabinet 13, not only insulation performance may be improved, but also an inflow of the external moisture and gas into the vacuum insulation panel 100 may be prevented. However, the embodiment is not limited to the case where the first outer shell material 110 is bonded to the inner surface of the outer cabinet 13, and the second outer shell material 120, instead of the first outer shell material 110, may also be bonded to the inner surface of the outer cabinet 13.

In addition, in the vacuum insulation panel 100, as described above in FIG. 6, the first outer shell material 110 and the second outer shell material 120 may be combined with each other to form an extension 140 that extends outward from the accommodation space 150. The extension 140 may be formed to extend outwards from both ends of the core material 130. The first outer shell material 110 and the second outer shell material 120 are bonded to each other at the extension 140 to maintain the accommodation space 150, in which the core material 130 is accommodated, in a vacuum state.

The core material 130 serves to maintain the shape of the vacuum insulation panel 100 and may be formed of a porous material. The core material 130 may be glass fiber, fumed silica, or the like having excellent insulation properties. For example, glass fiber used in the vacuum insulation panel 100 may be chopped long glass fiber with a diameter of 7 to 12 μm, glass wool with a diameter of 4 to 6 μm, and micro fiber with a diameter of 0.3 to 3 μm.

Glass fibers used as the core material 130 of the vacuum insulation panel 100 generally have a structure in which multiple layers are laminated. This is intended to reduce thermal conductivity between fibers by improving orientation of fibers.

Although glass wool was mainly used as the core material 130 in the past, insulation performance tends to decrease because a lot of fibers are oriented in the Z-axial direction due to random shapes and lengths of the fibers.

In the disclosure, insulation properties are improved by reducing vertical thermal conductivity, by laminating the vermiculite laminated films in the cores material 130 of the vacuum insulation panel 100, wherein the vermiculite laminated film includes: a first vermiculite sheet including a first surface with a positive charge; a second vermiculite sheet including a second surface with a positive charge and laminated on the first vermiculite sheet to allow the second surface to face the first surface of the first vermiculite sheet; and an anion interlayer between the first surface and the second surface.

In the disclosure, by laminating the vermiculite laminated film including the anion interlayer in the core material 130 of the vacuum insulation panel 100, a sufficient inter-layer distance between the vermiculite sheets may be obtained to reduce vertical thermal conductivity and a heat transfer path may be increased to improve insulation properties.

In consideration of only heat insulation properties, the vermiculite laminated film may be used as much as possible. However, if the number of the vermiculite laminated films is excessive, the vermiculite laminated films are accommodated in the accommodation space 150 too densely, so that gas and moisture adsorption function of the vermiculite laminated film may be hindered, and formation of uniform lattice may become difficult. In consideration thereof, 0.1 to 10 vol %, preferably 0.1 to 3.4 vol % of the vermiculite laminated film may be contained in the core material 130.

In addition, because the surface of the vermiculite sheet is modified with an amine group, the vermiculite laminated film according to the disclosure may have excellent ability to adsorb at least one of gas and moisture present in the accommodation space 150 or penetrating into the accommodation space 150 from the outside. Therefore, according to the disclosure, by including the vermiculite laminated film, a getter, provided in conventional vacuum insulation panels for adsorption of moisture and gas, may not be used or the amount of use thereof may be minimized.

Hereinafter, the disclosure will be described in more detail with reference to the following examples. However, the following examples are merely presented to exemplify the disclosure, and the scope of the disclosure is not limited thereto.

### Example 1. Preparation of Vermiculite Laminated Film

The first surface of the first vermiculite sheet and the second surface of the second vermiculite sheet of the vermiculite laminated film were modified to include an amine group by performing plasma treatment on the first surface and the second surface using N₂ gas. In this case, the plasma treatment was performed by applying 10 to 100 MHz of plasma at a power of 100 to 500 W at a temperature of 15 to 200° C. under a pressure of 50 to 500 mTorr for 5 seconds to 10 minutes.

An aqueous solution of a halide compound having a pH of 7 or less and a concentration of 30 wt % or less was applied to an interlayer between the first surface and the second surface including the amine group by plasma treatment with N₂ gas, and heat-treated to prepare a vermiculite laminated film including an anion interlayer.

The average inter-layer distance between the vermiculite sheets and vertical thermal conductivity in a vacuum according to the ion contained in the interlayer of the vermiculite laminated film were measured, and the results are shown in Table 1 below.

In this case, the average inter-layer distance between the vermiculite sheets was measured using a modified transient plane source (MTPS) method using a TCI device, and the vertical thermal conductivity was measured in a vacuum chamber after horizontally aligning the vermiculite laminated film to exclude heat transfer due to thermal conduction of gas.

TABLE 1

| | | Average inter- | |
|---|---|---|---|
| | | layer distance | Vertical thermal |
| | Ion of | between vermiculite | conductivity in |
| Category | interlayer | sheets (Å) | vacuum (mW/mK) |
| Example 1 | Cl⁻ | 3.34 | 7.56 |
| Example 2 | Br⁻ | 3.64 | 7.02 |
| Example 3 | I⁻ | 4.12 | 6.32 |
| Comparative | Mg²⁺ | 1.72 | 13 |
| Example 1 | | | |
| Comparative | Li⁺ | 1.8 | 12.8 |
| Example 2 | | | |
| Comparative | Ca²⁺ | 2.28 | 10.4 |
| Example 3 | | | |

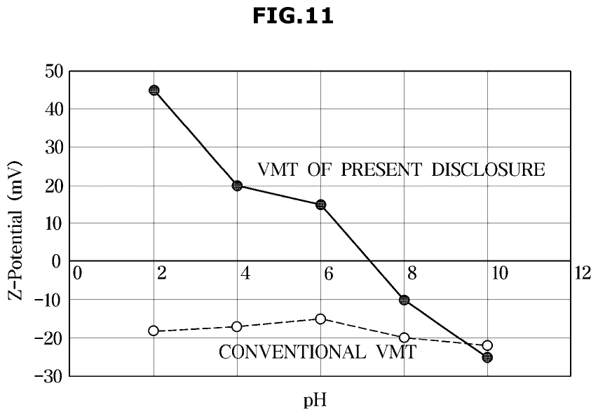

In addition, Z-potential values of the vermiculite laminated film prepared in Example 1 and the vermiculite laminated film prepared in Comparative Example 1 with respect to pH levels were measured, and the results are shown in FIG. 11.

A positive Z-potential value indicates that the surface of a material is positively charged, and a negative Z-potential value indicates that the surface of a material is negatively charged. As shown in FIG. 11, the Z-potential value of Comparative Example 1 was −10 mV or less throughout the entire pH range, so that it may be confirmed that the surface of the vermiculite laminated film has a negative charge. On the contrary, the Z-potential value of the vermiculite laminated film of Example 1 according to the disclosure was 0 or more at a pH of 7 or less, so that it may be confirmed that the surface of the vermiculite laminated film of Example 1 has a positive charge.

Based on these results, because the ionization of the amine group included in the surface of the vermiculite sheet is activated according to the disclosure, the surface of the vermiculite sheet has a positive charge allowing substation with anions in the interlayer. Therefore, it may be confirmed the average inter-layer distance between the vermiculite sheets may be efficiently increased.

### Example 2. Preparation of Vacuum Insulation Panel

As illustrated in FIG. 6, a vacuum insulation panel including a metal outer shell material to seal the inside in a vacuum state, and a glass wool core material disposed in the outer shell material and including 3.0 vol % of the vermiculite laminated film of Example 1 was prepared.

Thermal conductivity of the vacuum insulation panel including the vermiculite laminated film of Example 1 was measured, and the results are shown in Table 2 below. The thermal conductivity of the vacuum insulation panel was measured using a heat flow meter (HFM) device.

TABLE 2

| | Thermal |
|---|---|
| | conductivity |
| Category | (mW/mK) |
| core material + metal outer shell material | 2.27 |
| core material + conventional vermiculite + | 2.1 |
| metal outer shell material | |
| core material + vermiculite laminated film | 2.02 |
| of Example 1 + metal outer shell material | |

In addition, CO₂ gas and N₂ gas adsorption capacity and moisture adsorption capacity were measured by using the vacuum insulation panel including the vermiculite laminated film of Example 1 and the vacuum insulation panel including CaO, a conventional getter, without vermiculite, and the results are shown in Table 2 below.

The CO₂ gas and N₂ gas adsorption capacity and moisture adsorption capacity were measured by introducing the vacuum insulation panels into an analyzer, and measuring changes in gas composition and moisture content in the analyzer after tearing the vacuum insulation panels.

TABLE 3

| | CO₂ gas | | N₂ gas | | |
|---|---|---|---|---|---|
| | adsorption | | adsorption | | Moisture |
| | capacity | | capacity | | adsorption |
| | (mmol/g) | | (mmol/g) | | capacity |
| Category | vacuum | 1 atm | vacuum | 1 atm | (mmol/g) |
| Vacuum insulation | 0.13 | 2.5 | 0.2 | 4 | 194 |
| panel including | | | | | |
| vermiculite laminated | | | | | |
| film of Example 1 | | | | | |
| Vacuum insulation | — | — | — | — | 17.8 |
| panel including CaO | | | | | |
| getter | | | | | |

As shown in Tables 2 and 3, it was confirmed that the vacuum insulation panel including the vermiculite laminated film according to the disclosure, in which the surface of the vermiculite sheet includes an amine group by surface modification to have a positive charge, and anions are substituted in the interlayer between the surface-modified vermiculite sheets, may reduce thermal conductivity compared to the vacuum insulation panel not including vermiculite or including conventional vermiculite including cations in the interlayer without surface modification. Also, it was confirmed that excellent ability to adsorb gas and moisture was obtained without using the getter conventionally used in the vacuum insulation panel or using a minimized amount of the getter by using the vacuum insulation panel including the vermiculite laminated film according to the disclosure, which have excellent CO₂ gas and N₂ gas adsorption capacity and excellent moisture adsorption capacity.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A vermiculite laminated film for a vacuum insulation panel, the vermiculite laminated film comprising:
a first vermiculite sheet including a first surface with a positive charge;
a second vermiculite sheet including a second surface with a positive charge and laminated on the first vermiculite sheet to allow the second surface to face the first surface of the first vermiculite sheet; and
an anion interlayer between the first surface and the second surface.

2. The vermiculite laminated film according to claim 1, wherein the first surface and the second surface comprise an amine group.

3. The vermiculite laminated film according to claim 1, wherein the vermiculite laminated film has a vertical thermal conductivity of 8 mW/mK or less in a vacuum.

4. The vermiculite laminated film according to claim 1, wherein an average inter-layer distance between the first surface of the first vermiculite sheet and the second surface of the second vermiculite sheet is at least 3.3 Å but not more than 4.5 Å.

5. The vermiculite laminated film according to claim 1, wherein the anion interlayer comprises at least one halogen element selected from Cl, Br, I, and F.

6. The vermiculite laminated film according to claim 2, wherein the vermiculite laminated film has a CO₂ of 2.5 mmol/g or more under conditions of 1 atm.

7. The vermiculite laminated film according to claim 2, wherein the vermiculite laminated film has a N₂ gas adsorption capacity of 4 mmol/g or more under conditions of 1 atm.

8. A method of manufacturing a vermiculite laminated film for a vacuum insulation panel, the method comprising:
modifying a first surface of a first vermiculite sheet and a second surface of a second vermiculite sheet to have a positive charge; and
inducing substitution with anions in an interlayer between the first surface and the second surface, both modified to have a positive charge.

9. The method according to claim 8, wherein the modifying comprises performing plasma treatment using NH₃ or N₂ gas on the first surface of the first vermiculite sheet and the second surface of the second vermiculite sheet.

10. The method according to claim 8, wherein the modified first surface of the first vermiculite sheet and the modified second surface of the second vermiculite sheet comprise an amine group.

11. The method according to claim 8, wherein the substitution with anions is performed on the interlayer between the first surface and the second surface, both modified to have the positive charge, by applying a halide compound under conditions of pH of 7 or less and room temperature.

12. The method according to claim 11, wherein the halide compound comprises at least one selected from Cl⁻, Br⁻, I⁻, and F⁻.

13. The method according to claim 8, wherein an average inter-layer distance between the first surface of the first vermiculite sheet and the second surface of the second vermiculite sheet is at least 3.3 Å but not more than 4.5 Å.

14. A vacuum insulation panel comprising:
an outer shell material sealing an inside of the vacuum insulation panel in a vacuum state; and
a core material provided inside the outer shell material,
wherein the core material comprises a vermiculite laminated film comprising:
a first vermiculite sheet including a first surface with a positive charge,
a second vermiculite sheet including a second surface with a positive charge and laminated on the first vermiculite sheet to allow the second surface to face the first surface of the first vermiculite sheet, and
an anion interlayer between the first surface and the second surface.

15. The vacuum insulation panel according to claim 14, wherein the core material comprises 0.1 to 10 vol % of the vermiculite laminated film.

16. The vacuum insulation panel according to claim 14, wherein the first surface and the second surface comprise an amine group.

17. The vacuum insulation panel according to claim 14, wherein the vermiculite laminated film has a vertical thermal conductivity of 8 mW/mK or less in a vacuum.

18. The vacuum insulation panel according to claim 14, wherein an average inter-layer distance between the first surface of the first vermiculite sheet and the second surface of the second vermiculite sheet is at least 3.3 Å but not more than 4.5 Å.

19. The vacuum insulation panel according to claim 14,
wherein the outer shell material comprises a first outer shell material and a second outer shell material,
wherein the first outer shell material and the second outer shell material are coupled to form an accommodation for the core material, and
wherein the first outer shell material and the second outer shell material are coupled by one of fusion or adhesion.

20. The vacuum insulation panel according to claim 19,
wherein the first outer shell material has a first heat transfer rate, and
wherein the second outer shell material has a second heat transfer rate higher than the first heat transfer rate.
